(19) United States
(12) Patent Application Publication
(10) Pub. No.: US 2009/0071417 A1
(43) Pub. Date: Mar. 19, 2009

(54) Pet restraint

(76) Inventor: Finn Thomas Simmensen, Maricopa, AZ (US)

Correspondence Address: Finn T. Simmensen, 43251 West Caven Drive, Maricopa, AZ, 85238, US

(21) Appl. No.: 12/215,627

(22) Filed: Jun. 28, 2008

Related U.S. Application Data
(60) Provisional application No. 60/937,617, filed on Jun. 28, 2007.

(51) Int. Cl. A01K 27/00

(52) U.S. Cl. 119/793; 119/792

(57) ABSTRACT

A pet restraint includes a collar and a leash, the leash having handles at both ends and being slidingly disposed through a portion of the leash, either at a single point or at multiple points on the circumference of the leash. The leash also has blocking portions preventing the entire length of the leash from sliding through unintentionally. When the pet steps over the leash and begins pulling with the leash passing behind a leg, the person handling the pet may re-route the leash by grasping the end then disposed near the handle and letting go of the end previously held. Optionally, structure on the leash or on the collar permits easy disengagement of the leash from the collar

This application claims the benefit of Provisional Application Ser. No. 60/937,617, filed Jun. 28, 2007.

### BACKGROUND OF THE INVENTION

1. Field of the Invention

The present invention relates to pet leashes and especially to dog leashes.

2. General Background and State of the Art

A dog often steps over its leash, so that the owner and the dog walk for blocks with the leash chafing under the dog's front leg, or worse—depending on the dog's gender and after-market modifications—between its hind legs. This grates on the nerves of an owner, who can't imagine any creature liking the experience and thinks it tacky to walk a dog that way. An owner also finds it awkward to regain control of the leash—negotiating with the dog, flipping the leash around as if trying to teach the dog to jump rope, and finally reaching down, picking up the dog's foot, and repositioning the leash. Walking the dog should be fun. This isn't.

The dog seems not to care. It recently dawned on the inventor that the dog's center of mass is close to its shoulders and, with leash passing under-shoulder, the dog can't easily be pulled off its front feet. Keeping a balanced weight distribution, the dog can pull with all four legs. Having thus secured a mechanical advantage, the dog has a big vote in deciding where to go and at what pace. Indeed, the inventor might have discovered yet another clever adaptation of a species already known for its intelligence—the leash-under-shoulder trick for controlling a two-footed companion.

What would be appreciated is a graceful, inconspicuous approach to getting a leash out from between the legs of a dog.

### INVENTION SUMMARY

It is an object of the present invention to provide an improved restraint for walking a quadruped companion, especially a dog having the annoying habit of stepping over its leash and pulling with the leash between its legs.

In accordance with an exemplary embodiment of a pet restraint in accordance with the present invention, a pet restraint, comprising a collar and a leash, the leash having a first end and a second end and a sliding range determined lengthwise thereon between the first end and the second end, the leash being retained on the collar and being lengthwise slideable within the sliding range relative to the collar. While the sliding range is determined between the ends, the leash can't slide completely out of engagement with the collar.

In another exemplary embodiment, the leash includes a blocking portion proximate an end thereof and the blocking portion cooperates with the collar to limit the sliding range.

In another exemplary embodiment, the leash includes a loop proximate an end thereof.

In another exemplary embodiment, the leash further includes a loop proximate the blocking portion.

In another exemplary embodiment, the leash is retained on the collar over approximately 180 degrees around the collar.

A blocking portion can be distal or proximal to the loop, depending on the type of blocking portion and how it is to be un-blocked when the leash is to be disengaged from the collar. A blocking portion is formed with a knot, an extrusion, an injection molding, a ring, a tube, a perforated ball, a dowel, or other suitable, common structure.

Also in accordance with the present invention, a pet restraint comprises a collar including at least one leash-retaining portion and a leash having a first end, a second end, a length extending between the first end and the second end, and a sliding range within the length, the leash passing through the leash-retaining portion and being slideable, within the sliding range, relative to the leash-retaining portion.

In another exemplary embodiment, the leash includes a blocking portion proximate an end thereof and the blocking portion cooperates with the collar to determine a limit of the sliding range.

In another exemplary embodiment, the leash passes through the leash-retaining portion of the collar at a plurality of locations and the leash-retaining portion includes a leash-guiding structure between the locations.

In another exemplary embodiment, the leash-retaining portion is formed integrally with the collar.

In another exemplary embodiment, the leash-retaining portion subtends substantially 180 degrees around the collar.

In another exemplary embodiment, the leash-retaining portion includes a stiffened leash-guiding portion.

In another exemplary embodiment, the blocking portion is configurable either to pass through the leash-receiving portion or to interfere with the leash-retaining portion.

In another exemplary embodiment, the blocking portion includes a first segment formed and dimensioned to be passable through the leash-retaining portion of the collar and a second segment formed and dimensioned to be passable through the leash-retaining portion of the collar, the second segment being operatively connectable to the first segment in a first configuration such that the first segment and the second segment together are passable through the leash-retaining portion of the collar, the second segment being operatively connectable to the first segment in a second configuration such that the first segment and the second segment together are impassable through the leash-retaining portion of the collar.

In another exemplary embodiment, the leash includes a loop proximate an end thereof and wherein the loop includes a blocking portion, the blocking portion being manipulable to be passable through the leash-retaining portion or to be impassable therethrough.

A leash-retaining portion of a collar includes a ring, a tube, a coil, or a conduit or other structure suitable for slidably retaining a leash on a collar of a pet such as a dog.

In an exemplary embodiment, the first segment and the second segment are rotatably connected via a beveled joint, the joint being manually manipulable to stabilize the second segment relative to the first segment in the first configuration or, alternatively, in the second configuration.

The blocking portion can also be formed on the loop.

Also in accordance with the present invention, a pet restraint comprises a collar and a leash, the leash having a first end and a second end, the leash and collar cooperating either to retain the leash on the collar in lengthwise sliding relation to the collar within the sliding range, or to release the leash from the collar.

In another exemplary embodiment, the releasing cooperation includes endwise escape of an end of the leash from the collar.

In another exemplary embodiment, the endwise escape is facilitated by a torsionally configurable locking interference mechanism.

In another exemplary embodiment, the endwise escape is facilitated by a slidingly configurable locking interference mechanism.

In another exemplary embodiment, the releasing cooperation includes sideways escape of the leash from the collar.

Also in accordance with the present invention, a pet restraint comprises a pet collar, a guide attachable to and detachable from said pet collar; and a leash slidingly disposable through said guide and configurable to be held thereon via either end of said leash.

### BRIEF DESCRIPTION OF THE DRAWINGS

For a further understanding of the objects and advantages of the present invention, reference should be had to the following detailed description, taken in conjunction with the accompanying drawing, in which like parts are given like reference numbers and wherein:

FIG. 1 is a schematic representation of a pet restraint in accordance with the present invention;

FIG. 2 is a side perspective view thereof;

FIG. 3 is a partial perspective view thereof;

FIGS. 4-6 are shortened views of exemplary embodiments of a leash in accordance with the present invention;

FIG. 7 is a schematic representation of another exemplary embodiment of a pet restraint in accordance with the present invention;

FIG. 8 is a perspective view thereof;

FIG. 9 is a perspective view of the exemplary embodiment of FIG. 8;

FIG. 10 is a perspective view of another exemplary embodiment of a pet restraint in accordance with the present invention;

FIG. 11 is a perspective view of another exemplary embodiment of a pet restraint in accordance with the present invention;

FIG. 12 is a partial perspective view of the exemplary embodiment shown in FIG. 8;

FIG. 13 is a perspective view of another exemplary embodiment of the pet restraint in accordance with the present invention.

FIGS. 14-17 are partial perspective views of another exemplary embodiment of the pet restraint in accordance with the present invention;

FIGS. 18-19 are partial cross-sectional views of another exemplary embodiment of the pet restraint in accordance with the present invention.

FIG. 20 is a partial side view of another exemplary embodiment of the pet restraint in accordance with the present invention;

FIGS. 21-22 are partial perspective views of another exemplary embodiment of the pet restraint in accordance with the present invention; and

FIG. 23 is a partial cross sectional view of the exemplary embodiment shown in FIGS. 21-22;

FIG. 24 is a partial side view of another exemplary embodiment of the pet restraint in accordance with the present invention;

FIG. 25 is a perspective view of another exemplary embodiment of the pet restraint in accordance with the present invention;

FIG. 26 is a partial side view of the embodiment of FIG. 25;

FIG. 27 is a view including a section of a portion of the embodiment of FIG. 25; and

FIG. 28 is a combined perspective and partial sectional view of another exemplary embodiment of the pet restraint showing stop canisters and a caribiner.

### DETAILED DESCRIPTION OF THE PREFERRED EMBODIMENTS

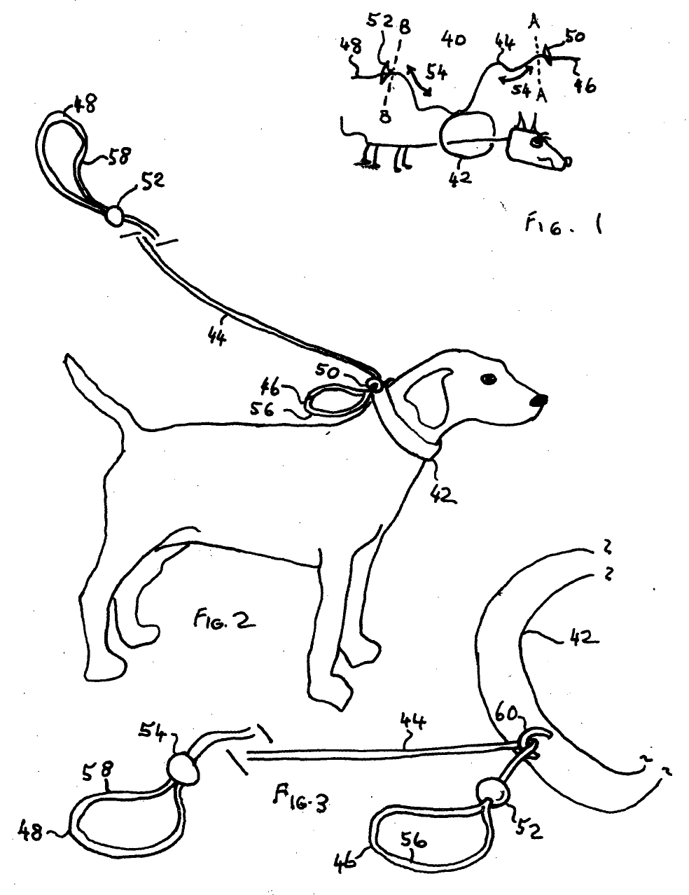

The invention will now be described in the context of handling a dog with reference to FIG. 1, which represents schematically an exemplary embodiment of the pet restraint in accordance with the present invention, shown generally at 40, having a collar 42 and a leash 44. The leash 44 has a first end 46 and a second end 48. A first blocking portion 50 is disposed on the leash 44 proximate the first end 46. A second blocking portion 52 is disposed on the leash 44 proximate the second end 48. A sliding range 54 is determined lengthwise on the leash 44 between the first blocking portion 50 and the second blocking portion 52. The leash 44 is retained on the collar 42 and is lengthwise slideable within the sliding range 54, between locations A-A and B-B on the leash 44, relative to the collar 42.

As represented in FIG. 1 and described in the preceding paragraph, the leash 44 is retained on the collar 42 in the most general sense, which sense is intended to include any structure providing for restraint of a dog wearing the collar 42 when at least one of the first end 46 and the second end 48 of the leash 44 is held in tensile relation to the collar 42. At a comparable level of generality, the first blocking portion 50 includes any structure interfering with the collar 42 in a manner preventing the first end 46 of the leash 44 from disengaging from the collar 42 when the second end 48 alone of the leash 44 is held in tensile relation to the collar 42. Such is likewise true, swapping end for end, for the second blocking portion 52.

With continued reference to FIG. 1, a handler may hold the leash 44 by the second end 48 while the dog pulls the collar 42 away until the first blocking portion 50 interferes with the collar 42, whereupon the leash 44 is in tensile relation to the collar 42. When the dog steps over the leash 42, so that the leash becomes entrained between the dog's chest and front leg or, as will also happen on occasion, between the dog's hind legs, the handler may approach the dog, grasp the first end 46 of the leash 44, and release the second end 48 of the leash 44. As the dog again pulls away, the leash 44 will slide relative to the collar 42 until the second blocking portion 52 interferes with the collar 42, whereupon tension is conveniently reestablished, the leash 44 extending directly to the collar 44 at the dog's neck without passing beneath the dog.

FIG. 2, a perspective view of a pet restraint in accordance with the present invention, shows a dog wearing a collar 42 to which is attached a leash 44 having a first end 46, as second end 48, a first blocking portion 50, a second blocking portion 52, a first loop 56, and a second loop 58.

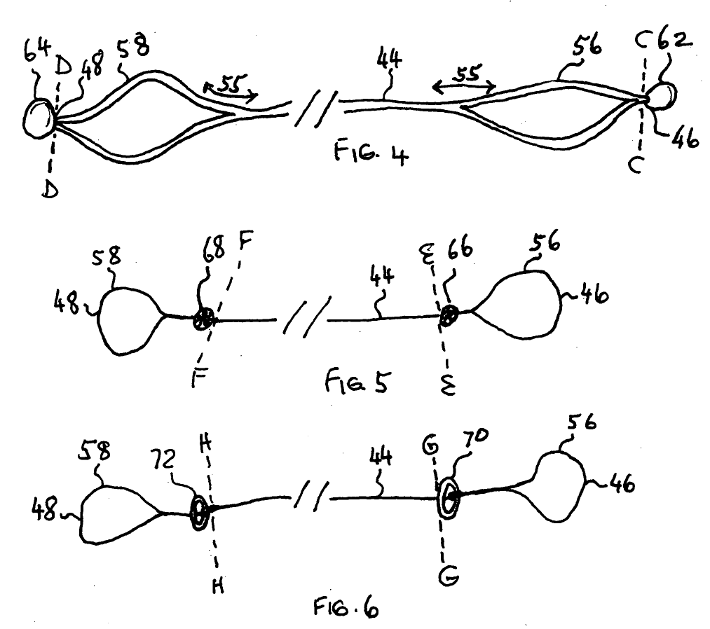

FIG. 3, a partial perspective view of a pet restraint in accordance with the present invention, shows a collar 42 and a leash 44 with first end 46, second end 48, first blocking portion 50, second blocking portion 52, first loop 56, and second loop 58. Also shown in FIG. 3 is a half-ring 60 anchored in the collar 42.

With reference to FIG. 2 and FIG. 3, the half-ring 60 retains the leash 44 on the collar 42. The half-ring 60, the first blocking portion 50 and the second blocking portion 52 are formed and dimensioned such that neither the first blocking portion 50 nor the second blocking portion 52 is passable through the half-ring 60. Thus, the leash 44 may be held either by the first end 46 (with the second blocking portion 52 and half-ring 60 cooperating to prevent disengagement of the leash 44 from the collar 42) or by the second end 48 (with the first blocking portion 50 and half-ring 60 cooperating to prevent disengagement of the leash 44 from the collar 42). With the handler holding the second end 48 of the leash 44, when the dog steps over the leash 42, the handler may approach the dog, grasp the first end 46 of the leash 44, and release the second end 48 of the leash 44. As the dog again pulls away, the leash 44 will slide relative to the collar 42 until the second blocking portion 52 interferes with the half-ring 60 of the collar 42, whereupon tension is conveniently reestablished, the leash 44 extending directly to the collar 44 at the dog's neck without passing beneath the dog.

With reference to FIGS. 1-3, the collar 42 and leash 44 may be formed of leather, fabric (nylon, polyester, or the like), rubber, rope or other commonly available materials. The half-ring 60 may be formed of metal, polymer, or the like, may be stiff or limp, so long as it cooperates with the leash 44 and balls 52 and 54 as shown and described, and may be attached to the collar 42 by commonly available means such as stitching, embedding, molding, tying, or bolting. The loops 56 and 58 may be formed by any convenient means of attaching leash material to itself or to a solid object, such as by stitching, gluing, tacking, or welding. The balls 52 and 54 may be formed of rubber, wood, metal, polymer, glass or the like.

FIG. 4, a shortened view of an exemplary embodiment of a leash 44 in accordance with the present invention, shows the leash 44 having a first end 46, second end 48, first loop 56, second loop 58, first ball 62 and second ball 64. Notably, the first loop 56 is proximal to the first ball 62; likewise, the second loop 58 is proximal to the second ball 64. Thus, in this exemplary embodiment, the first ball 62 and second ball 64 determine a sliding range 55 which extends from location C-C to location D-D on the leash 44 and includes the first loop 56 and the second loop 58 of the leash 44. Accordingly, when the handler holds the second end 48 of the leash 44, the first ball 62 will interfere with the collar 42 (at the half-ring 60 thereof, FIG. 3, for example), thereby preventing disengagement of the first end 46 of the leash 44 from the collar 42. With the handler holding the second end 48 of the leash 44 (either by the second loop 58, by the second ball 64, or by some other, intermediate portion of the leash 44), when the dog steps over the leash 42, the handler may approach the dog, grasp the first ball 62 of the leash 44 (which is likely then abutting the half-ring 60) and release the second end 48 of the leash 44. As the dog again pulls away, the leash 44 will slide relative to the collar 42 until the second ball 64 interferes with the half-ring 60 of the collar 42, whereupon tension is conveniently reestablished, the leash 44 extending directly to the collar 44 at the dog's neck without passing beneath the dog. It will be noted that the second loop 58, being proximal to the second ball 64 in this exemplary embodiment, will not dangle free if the leash 44 is in tensile relation to the collar 42 and is, therefore, less likely to become ensnared in shrubbery or the like.

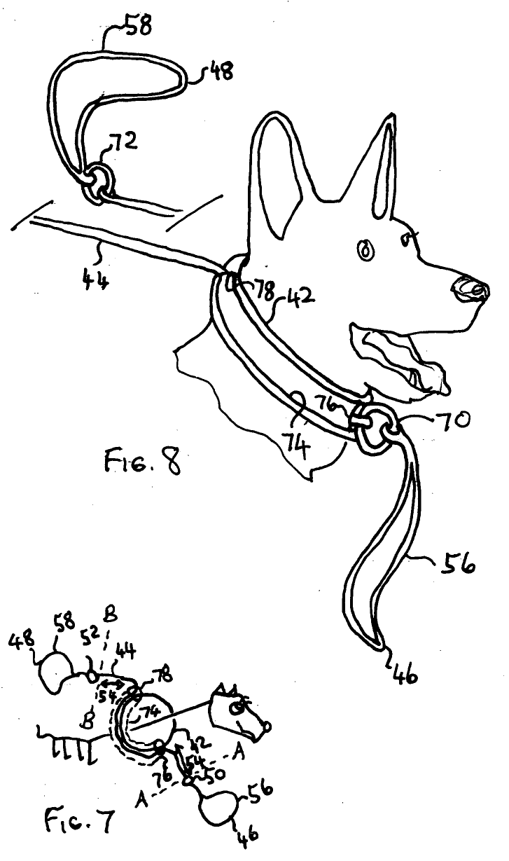

FIG. 5, a shortened view of another exemplary embodiment of a leash 44 in accordance with the present invention, shows the leash 44 having a first end 46, second end 48, first loop 56, second loop 58, and first knot 66 and second knot 68 tied in the leash 44. The first knot 66 and second knot 68 determine a sliding range 54 which extends from location C-C to location D-D on the leash 44 and includes the first loop 56 and the second loop 58 of the leash 44. Accordingly, when the handler holds the second end 48 of the leash 44, the first knot 66 will interfere with the collar 42 (at the half-ring 60 thereof, FIG. 3, for example), thereby preventing disengagement of the first end 46 of the leash 44 from the collar 42 and placing the first loop 56 near the collar 42, where it may later be reached for. With the handler holding the second end 48 of the leash 44 (either by the second loop 58 or by some other, intermediate portion of the leash 44), when the dog steps over the leash 42, the handler may approach the dog, grasp the first loop 56 of the leash 44 (which is likely then located close to the half-ring 60) and release the second end 48 of the leash 44. As the dog again pulls away, the leash 44 will slide relative to the collar 42 until the second knot 68 interferes with the half-ring 60 of the collar 42, whereupon tension is conveniently reestablished, the leash 44 extending directly to the collar 44 at the dog's neck without passing beneath the dog. It will be noted that the second loop 58, being distal to the second knot 68 in this exemplary embodiment, is then positioned near the collar 42 where it may easily be reached.

FIG. 6, a shortened view of another exemplary embodiment of a leash 44 in accordance with the present invention, shows the leash 44 having a first end 46, second end 48, first loop 56, second loop 58, first stopping ring 70 and second stopping ring 72. The first stopping ring 70 and second stopping ring 72 determine a sliding range 54 which extends from location C-C to location D-D on the leash 44 and includes the first loop 56 and the second loop 58 of the leash 44. Accordingly, when the handler holds the second end 48 of the leash 44, the first stopping ring 70 will interfere with the collar 42 (at the half-ring 60 thereof, FIG. 3, for example), thereby preventing disengagement of the first end 46 of the leash 44 from the collar 42 and placing the first loop 56 near the collar 42, where it may later be reached for. With the handler holding the second end 48 of the leash 44 (either by the second loop 58 or by some other, intermediate portion of the leash 44), when the dog steps over the leash 42, the handler may approach the dog, grasp the first loop 56 of the leash 44 (which is likely then located close to the half-ring 60) and release the second end 48 of the leash 44. As the dog again pulls away, the leash 44 will slide relative to the collar 42 until the second stopping ring 72 interferes with the half-ring 60 of the collar 42, whereupon tension is conveniently reestablished, the leash 44 extending directly to the collar 44 at the dog's neck without passing beneath the dog. It will be noted that the second loop 58, being distal to the second stopping ring 72 in this exemplary embodiment, is then positioned near the collar 42 where it may easily be reached. The rings 70 and 72 are formed of any suitably strong and rigid material such as metal or nylon and may be attached to the leash 44 by knotting, stitching, rivets, tacks, or the like.

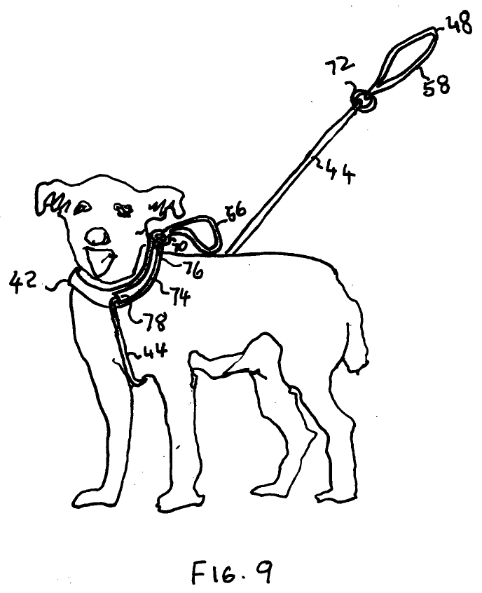

FIG. 7, a schematic representation of another exemplary embodiment of the pet restraint in accordance with the present invention, shown generally at 40, shows a collar 42 and a leash 44. The leash 44 has a first end 46 and a second end 48. A first blocking portion 50 is disposed on the leash 44 proximate the first end 46, which forms a first loop 56 distal to the first blocking portion 50. A second blocking portion 52 is disposed on the leash 44 proximate the second end 48, which forms a second loop 58 distal to the second blocking portion 52. A sliding range 54 is determined lengthwise on the leash 44 between the first blocking portion 50 and the second blocking portion 52.

With continued reference to FIG. 7, the collar 42 includes a leash-retaining portion 74 having a first leash-receiving end 76 and a second leash-receiving end 78. As shown in FIG. 7 and as described in this paragraph, the leash-retaining portion 74 extends, in the most general sense, between the first leash-receiving end 76 and the second leash-receiving end 78. At a comparable level of generality, the leash-retaining portion 74 includes any structure operatively connected to the collar in a manner preventing the leash 44 from disengaging from the collar 42 when at least one of the first end 46 and the second end 48 of the leash 44 is held in tensile relation to the collar 42, whereby the leash 44 is retained on the collar 42 and is lengthwise slideable within the sliding range 54, between locations A-A and B-B on the leash 44, relative to the collar 42.

With continued reference to FIG. 7, a handler may hold the leash 44 by the second end 48 while the dog pulls the collar 42 away until the first blocking portion 50 interferes with the first leash-receiving end 76 of the leash-retaining portion 74 of the collar 42, whereupon the leash 44 is in tensile relation to the collar 42. When the dog steps over the leash 42, the handler may approach the dog, grasp the first end 46 of the leash 44, and release the second end 48 of the leash 44. As the dog again pulls away, the leash 44 will slide relative to the collar 42 until the second blocking portion 52 interferes with the second blocking portion 52 interferes with the second leash-receiving end 78 of the leash-retaining portion 74 of the collar 42, whereupon tension is conveniently reestablished, the leash 44 extending directly to the collar 44 at the dog's neck without passing beneath the dog.

FIG. 8, a perspective view of a pet restraint in accordance with the present invention, shows a dog wearing a collar 42 including a leash-retaining portion 74 having a first leash-receiving end 76 and a second leash-receiving end 78 located about half-way around the collar (i.e., about 180 degrees around the collar) from the first leash-receiving end 76. The leash-retaining portion 74 in this exemplary embodiment is formed by stitching a strip of material onto the collar 42 loosely enough to accommodate the leash 44 passing beneath it, yet tightly enough to form the first leash-receiving end 76 and the second leash-receiving end 78 so that they will interfere with the first stopping ring 70 and the second stopping ring 72, respectively. A leash 44 is shown having a first end 46, as second end 48, a first stopping ring 70, a second stopping ring 72, a first loop 56, and a second loop 58.

With continued reference to FIG. 8, the first leash-receiving end 76 and the first stopping ring 70 are formed and dimensioned such that the first stopping ring 70 is not passable through the first leash-receiving end 76. The same relationship holds for the second leash-receiving end 78 and the second stopping ring 72. The leash 44 passes through the leash-retaining portion 74 of the collar 42. FIG. 8 shows the leash 44 in tensile relation to the collar 42, as when a handler holds the second end 48 of the leash 44. Accordingly, as shown, the leash 44 has slid through the leash-retaining portion 74 and the first stopping ring 70 abuts the first leash-receiving end 76 of the leash-retaining portion 74, preventing disengagement of the leash 44 from the collar 42. In this condition, with the tension in the leash 44 coming from above and to the rear, the second leash-receiving end 78 of the leash-retaining portion 74 is oriented upward and the first leash-receiving end 76, being half-way around the collar, is therefore oriented downward.

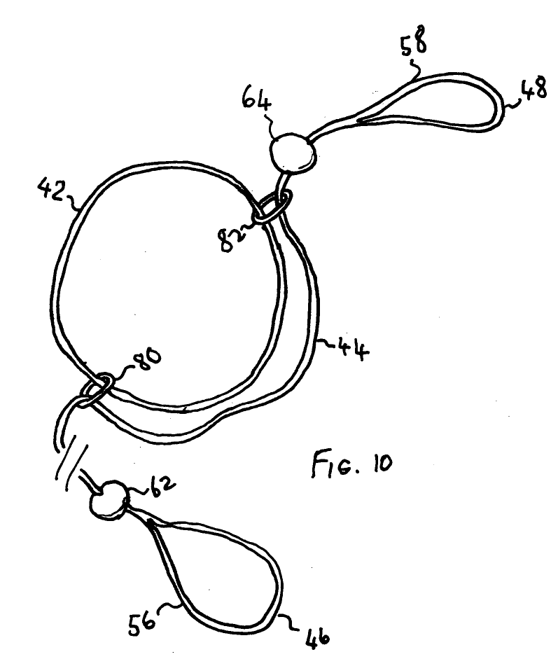

FIG. 9 is a perspective view of the exemplary embodiment of FIG. 8 after the dog has stepped over the leash 44, with the result that the leash 44 is shown extending downward from the collar 42, across the dog's chest, rearward between the dog's chest and shoulder, and then ascending rearward with the second end 48 positioned as if held in tension by the handler. Under downward tension from the leash 44, the second leash-receiving end 78 of the leash-retaining portion 74 of the collar 42 is oriented downward. Thus, the first leash-receiving end 76, being half-way around the collar from the second leash-receiving end 78, is oriented upward, close to the top of the dog's neck. Also due to the tension in the leash 44, the first stopping ring 70 of the leash 44 at this time interferingly abuts the first leash-receiving end 76. Thus, the first loop 56 of the leash 44 is thus held extending upward and positioned at the top of the dog's neck, where it may conveniently be grasped by the handler.

With continued reference to FIG. 9, the handler may then regain proper control of the dog's neck by grasping the first loop 56 of the leash 44, releasing the second loop 58 of the leash 44, and applying tension to the first end 46 of the leash 44 by pulling on the first loop 56, whereupon the leash 44 will slide through the leash-retaining portion 74 of the collar 42 until the second stopping ring 72 interferes with the second leash-receiving end 78. Once again, the leash 44 will pass directly from the handler to the collar 42 on the dog's neck and not beneath the dog. The handler will have regained control of the dog's neck via the collar without engaging in any delicately timed maneuvers, manipulating the dog's leg, or distracting the dog.

With continued reference to FIGS. 7-9, an additional cooperation is observed between the leash 44 and the collar 42: the collar 44, namely that, when the dog pulls on the leash 44, the leash-retaining portion 74 is squeezed between the first leash-receiving end 76 and the second leash-receiving end 78. To a variable degree depending on how stiff the collar 44 is and how stiff the leash-retaining portion 74 is, tension on the leash 44 through the leash-retaining portion 74 tends to shorten or to ripple. As a result, the circumference of the collar 44 decreases, mildly constricting the collar on the dog's neck. This constriction, similar to that obtained with a commonly available choke-chain collar, might help to prevent the dog from backing out of the collar. However, constriction might also be regarded as being undesirable on the ground that it would make the dog uncomfortable or nervous. Additionally, any shortening or rippling of the leash-retaining portion 74 might cause the leash 44 to bind and not to slide as intended relative to the collar 44. Considering these factors, it may be preferable to provide the collar 44, the leash-retaining portion 74, or both with sufficient stiffness to hold their native shape under the loads they are expected to bear.

With continued reference to FIGS. 7-9, the leash-retaining portion 74 is formed of any suitable material such as a tough nylon fabric, a sheet of reinforced rubber, or, for that matter, a spiral of a series of loops of heavy thread, wire, rope or the like, so long as a channel is provided on the collar 42 for the leash 44 to slide.

FIG. 10, a perspective view of another exemplary embodiment of a pet restraint in accordance with the present invention, shows a collar 42 having a first leash-retaining ring 80 and a second leash-retaining ring 82 each fixed about half-way around the collar from the other. Also shown is a leash 44 having a first end 46, a second end 48, a first loop 56, a second loop 58, a first ball 62, and a second ball 64. This exemplary embodiment functions in a manner similar to that described generally with reference to FIG. 7 and more specifically with reference to FIGS. 8 and 9. However, the embodiment shown by FIG. 10 lacks structure, other than the collar 42 itself, between the first leash-retaining ring 80 and the second leash-retaining ring 82. Therefore, this embodiment will be only as stiff as the collar 42. Accordingly, if the collar 42 is formed of a limp material, such as a woven polyester strap, even mild tension on the leash 44 will cause the collar 42 to constrict about the dog's neck. Moreover, even with a stiff collar 42, the leash 44 under tension will tend to bite into the dog's neck and chafe at the dog's fur or skin. In such a case, it is beneficial to form the leash 44 of a broad, slippery, abrasion-resistant material and to form the first leash-retaining ring 80 and the second leash-retaining ring 82 with smooth surfaces and gently curving edges.

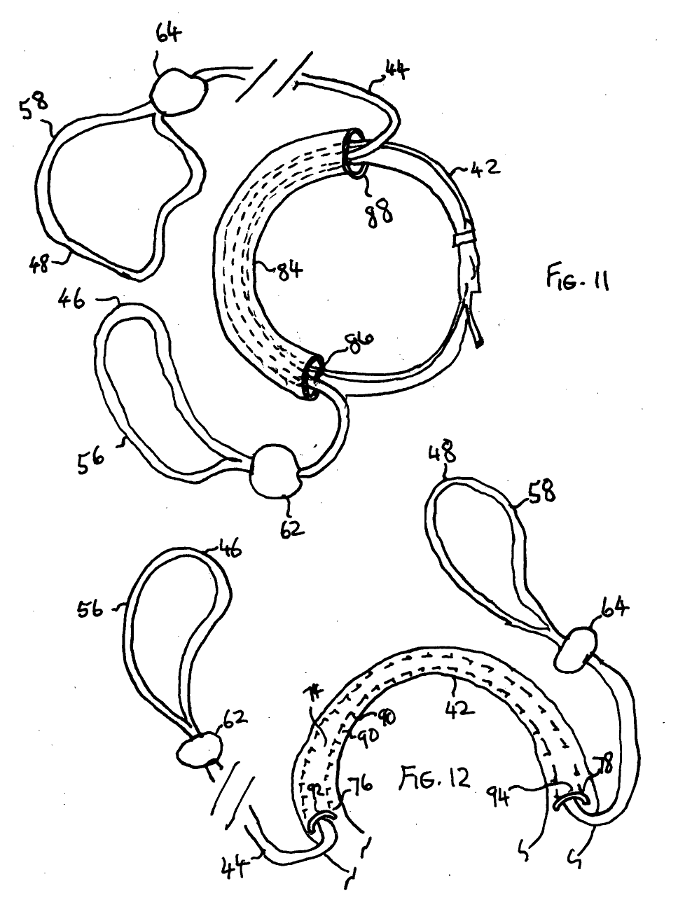

FIG. 11, a perspective view of another exemplary embodiment of the pet restraint in accordance with the present invention, shows a collar 42 including a leash-retaining tube 84 which as been threaded onto the collar 44 before the collar 44 is closed. The leash-retaining tube 84 has a first leash-receiving orifice 86 and a second leash-receiving orifice 88 located about half-way around the collar (i.e., about 180 degrees around the collar) from the first leash-receiving orifice 86. The leash-retaining tube 84 in this exemplary embodiment is formed of polyvinyl chloride, nylon, hard rubber, polyethylene, metal, or the like. Also shown is a leash 44 having a first ball 62, a second ball 64, a first loop 56, a second loop 58, a first end 46 and a second end 48.

With continuing reference to FIG. 11, the leash 44 is slideably disposed in the leash-retaining tube 84. The first leash-receiving orifice 86 and the first ball 62 are formed and dimensioned such that the first ball 62 is not passable through the first leash-receiving orifice 86. The same relationship holds for the second ball 64 and the second leash-receiving orifice 88. In use, this exemplary embodiment functions in the manner described above with reference to FIGS. 8 and 9. However, this embodiment does not require stitching in order to provide structure between the first leash-receiving orifice 86 and the second leash-receiving orifice 88, thereby substituting a simple assembly step for a more capital-intensive processing step. If the leash-retaining tube 84 is formed of a relatively limp material, tension on the leash 44 will more readily lead to constriction of the collar 44 on the dog's neck and also possibly to binding of the leash 44 relative to the collar 42.

With continued reference to FIG. 11, the leash-retaining tube 84 is formed of polyvinyl chloride, rubber, polyester, polyethylene, metal, fabric, or the like and may have its ends reinforced with metal or another suitably rigid and abrasion resistant material. The materials of the leash-retaining tube 84 and that of the collar 42 are selected and dimensioned to provide a desirable degree of stiffness for the overall combination of the leash-retaining tube 84 and the collar 42, with consideration given to the loads expected from dogs the collar 42 will fit. If a given structure experiences excessive binding, constriction or deformation under load, it may be redesigned or reformulated for greater stiffness. If it is too stiff, it might be made softer.

FIG. 12, a perspective view of another exemplary embodiment of the pet restraint in accordance with the present invention, shows a collar 42 including a leash-retaining portion 74 having a first leash-receiving end 76 with a first reinforcing ring 92 and a second leash-receiving end 78, with a second reinforcing ring 94, located about half-way around the collar (i.e., about 180 degrees around the collar) from the first leash-receiving end 76. The leash-retaining portion 74 in this exemplary embodiment is attached by stitching 90 to the collar 42 and is stitched loosely enough to accommodate the leash 44 passing beneath it. The first reinforcing ring 92 and the second reinforcing ring 94 are formed and dimensioned so that they will interfere with the first ball 62 and the second ball 64, respectively, and are formed of a material, such as nylon or metal, tough enough to resist abrasion by the leash 44 and forceful impingement of the first ball 62 and second ball 64. A leash 44 is shown having a first end 46, a second end 48, a first ball 62, a second ball 64, a first loop 56, and a second loop 58. This embodiment closely resembles that shown in FIGS. 8 and 9, but shows the stitched leash-retaining portion 74 in greater detail, adds the first reinforcing ring 92 and second reinforcing ring 94, and substitutes the first ball 62 and second ball 64 for the stopping rings 70 and 72 in FIGS. 8 and 9.

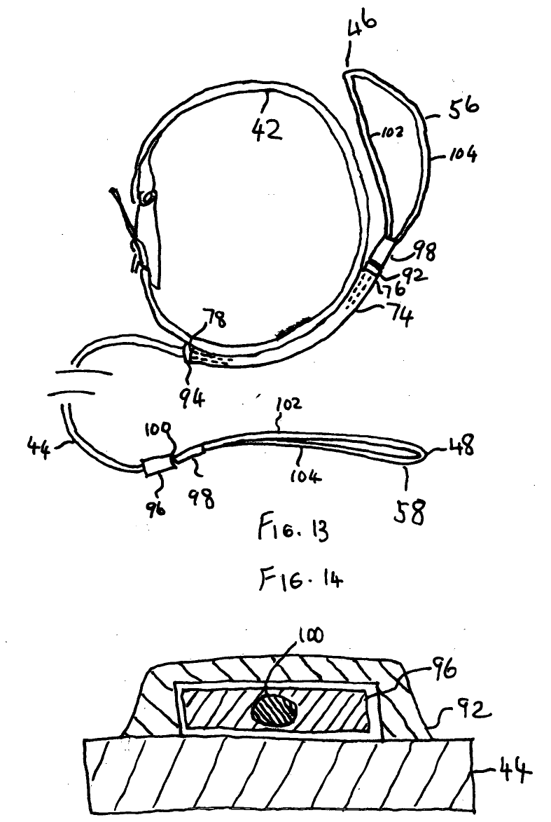

FIG. 13 shows a partial perspective view of another exemplary embodiment of a pet restraint in accordance with the present invention including a collar 42 on which is formed a leash-retaining portion 74 which extends about a third of the way around the collar 42 and has a first leash-receiving end 76 equipped with a first reinforcing ring 92 and a second leash-receiving end 78 equipped with a second reinforcing ring 94. A leash 44 is slideably disposed through the leash-retaining portion 74 and has a first end 46, first loop 56, second end 48, and second loop 58. Proximal to each of the first loop 56 and the second loop 58, the leash 44 has a flattened rectangular first stopping segment 96 joined by a link 100 to a flattened rectangular second stopping segment 98, which is joined to the first branch 102 and the second branch 104 of the first loop 56. The same structure is found at the second end 48. The link 100 is rotatable between two locked configuration. In the first locked configuration, the second stopping segment 98 is aligned with the first stopping segment 96 and both are passable through the first reinforcing ring 92, first leash-receiving end 76, leash-retaining portion 74, second leash-receiving end 78 and second reinforcing ring 94. In the second locked configuration, the second stopping segment 98 is misaligned with (oriented at 90 degrees relative to) the first stopping segment 96, so that, although the first stopping segment 96 alone may pass into the first leash-receiving end 76, the second stopping segment 98 will interfere with the first reinforcing ring 92, preventing the first loop 56 from entering or passing through the leash-retaining portion 74 of the collar 44.

FIG. 14 shows a cross sectional view of the exemplary embodiment shown in FIG. 13 including the collar 42, first reinforcing ring 92, first stopping segment 96 and link 100.

FIG. 15 shows a cross sectional view of the second stopping segment 98 superimposed over the structures earlier represented in FIG. 14. The second stopping segment 98 is shown misaligned with the first stopping segment 96 and, therefore, in interfering relation to the first reinforcing ring 92.

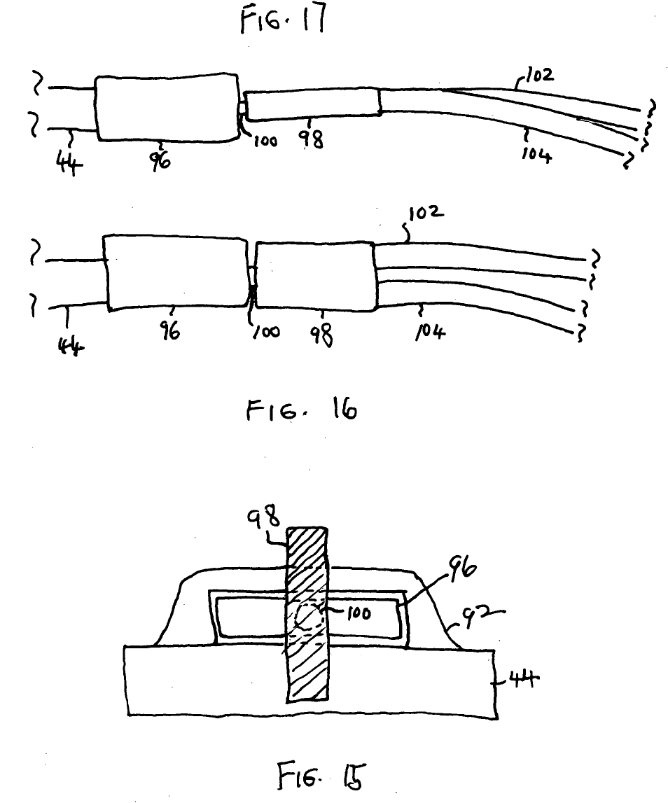

FIGS. 16-17 show partial perspective views of the embodiment shown in FIGS. 14-15 including the leash 44, the first stopping segment 96, the link 100, the second stopping segment 98, and the first branch 102 and second branch 104 of the first loop 56 (or the second loop 58). The first stopping segment 96 and the second stopping segment 98 are shown aligned in FIG. 16 and misaligned in FIG. 17.

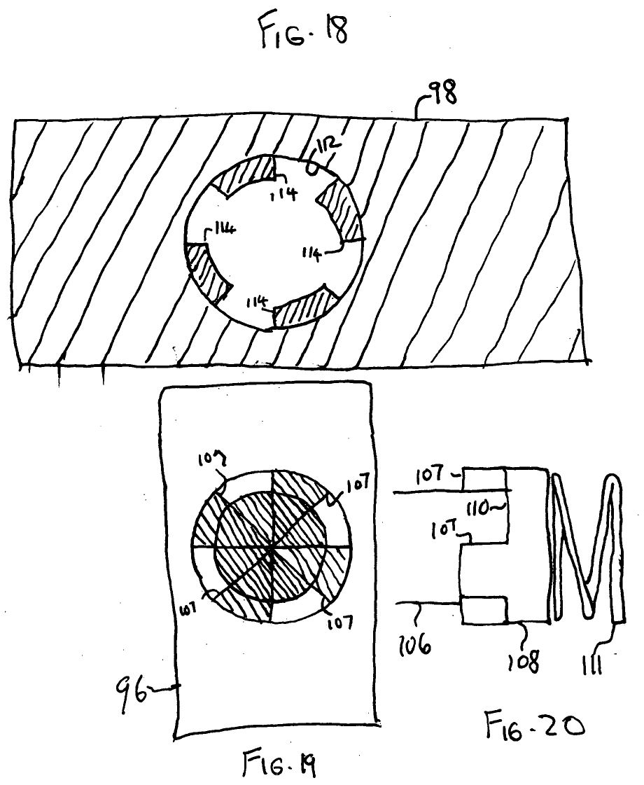

FIGS. 18-19 show a cross sectional view of the first stopping segment 96, the link 100 and the second stopping segment 98. As shown in FIGS. 19-20, the link, which projects from the first stopping segment 96 (although it could as easily project the other way from the second stopping segment 98), has a key 106 with an enlarged head 108 the backside 110 of which is cut radially inward toward the key 106 to form four wings 107 each subtending approximately 45 degrees about the longitudinal axis of the shaft and spaced 90 degrees apart. A spring 111 is disposed against the head 108.

Correspondingly, as shown in FIG. 18, the second stopping segment 98 forms a keyway 112 having four teeth 114 which project radially inward toward the longitudinal axis of the link 100. It will be appreciated that the key 106 is insertable in the keyway 112, whereupon it compresses the spring 111 within the keyway (the keyway is of finite length). The second stopping segment 98 can then be sealed up to permanently trap the key 106 in the keyway 112 while the spring 111 urges the key 106 backward, causing the wings 107 of the key 106 to engage the teeth 114 of the keyway 112 unless the key 106 is forced into the keyway 112, which may be accomplished by grasping the first stopping segment 96 in one hand, the second stopping segment 98 in the other, and pressing the two toward one another. In this manner, the first stopping segment 96 and the second stopping segment 98 can be rotated relatively between aligned and misaligned configurations. This arrangement is preferred—i.e., the link 100 locks when under tension or when slack, and unlocks to allow a change of configuration only when the first stopping segment 96 and the second stopping segment 98 are pressed toward one another—because it is important to prevent disengagement of the leash 44 from the collar 42 when the dog is pulling.

With continued reference to FIGS. 13-20, which may be regarded as illustrating an embodiment of a pet restraint in accordance with the present invention employing a torsionally configurable locking interference mechanism, the collar 42 and leash 44 are formed as described previously herein for other embodiments. The first and second stopping segments 96 and 98 and the link 100 are formed of a strong metal or a stiff, high-tensile-strength polymer. The teeth 114 and the wings 107 are best made of high-strength steel. The spring 111 is preferably formed of spring steel.

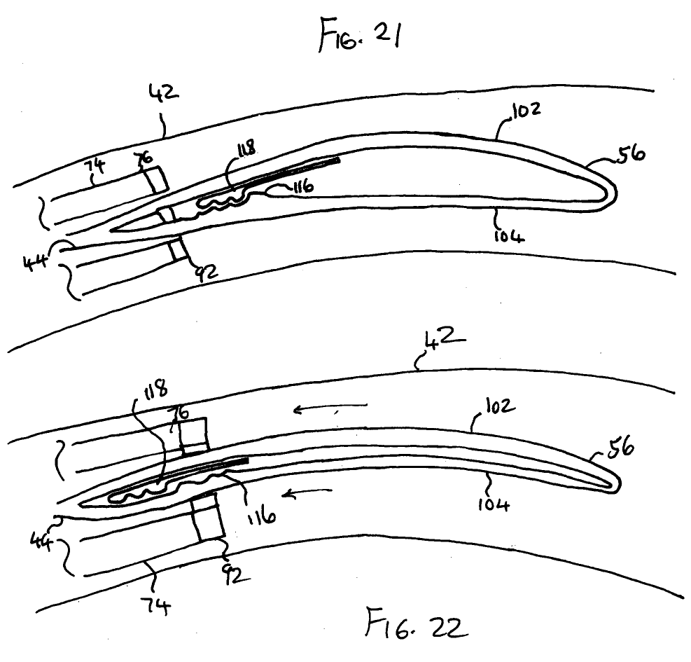

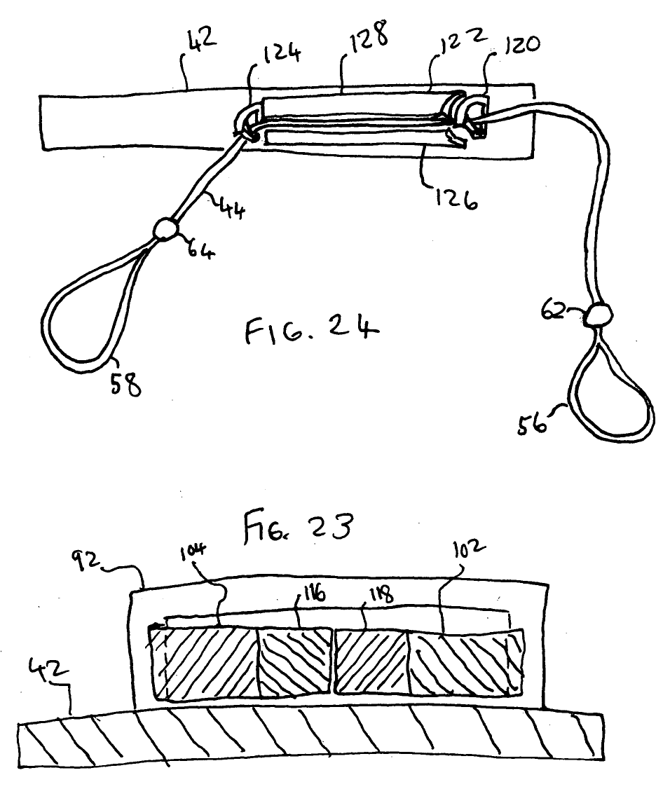

FIGS. 21-22 show partial perspective views of another exemplary embodiment of the pet restraint in accordance with the present invention configured to prevent disengagement of the leash 44 from the collar 42 (FIG. 21) and to allow disengagement and reengagement (FIG. 22).

In FIG. 21, the first loop 56) is shown approximated to the first reinforcing ring 92 at the first leash-receiving end 76 of the leash-retaining portion 74 of the collar 42 with the leash 44 extending into the leash-retaining portion 74 and the first branch 102 and the second branch 104 of the first loop 56 projecting proximate the collar 42. The first branch 102 and the second branch 104 are formed of a material having high tensile strength (such as nylon or a resin-impregnated fabric body) combined with a mild degree of stiffness so that, when pressed together side by side, they may be either pushed or pulled through the leash-retaining portion 74 of the collar 42—provided, of course, that they are not, in combination, too wide to pass through. The second branch 104 includes a serrated pedestal 116 projecting toward the first branch 102. The first branch 102 includes a matchingly serrated wedge 118 projecting toward the second branch 104. FIG. 21 shows the wedge 118 in positioned to opposingly engage the pedestal 116, such that the first branch 102 and the second branch 104 remain spaced apart. As a result, the first loop 56 is too wide to fit through the first reinforcing ring 92 and will not pass through the leash-retaining portion 74. The leash 44 remains engaged with the collar 42.

In FIG. 22, the wedge 118, which is movably attached to the first branch 102, is shown offset relative to the pedestal 116, such that the first branch 102 and the second branch 104 can be approximated one to another closely enough that the first loop 56 can pass through the leash-retaining portion 74, allowing convenient disengagement of the leash 44 from the collar 42 when the dog is at home and the handler does not wish to remove the collar 42 from the dog. When it is time to reengage the leash 44 with the collar 42, the handler may thread the first loop 56 through the leash-retaining portion 74 of the collar 42 (either through the first leash-receiving end 76 or through the second leash-receiving end 78), an activity which the mildly stiff first branch 102 and second branch 104 makes easy. To assure sustained engagement of the leash 44 with the collar 42, the handler need only make sure that the wedges 118 at both the first loop 56 and the second loop 58 are positioned in interfering opposition to the corresponding pedestals 116.

FIG. 23 shows a partial cross sectional view of this embodiment as shown in shown in FIG. 21 including the collar 42 and the first reinforcing ring 92, which is dimensioned to confine the first branch 102 with wedge 118 and second branch 104 with pedestal 116 in proper interfering opposition to one another so that, as is the visible result in FIG. 23 as in FIG. 21, the first loop 56 is too wide to pass through the first reinforcing ring 92.

With continued reference to FIGS. 21-23, which may be regarded as illustrating an exemplary embodiment of a pet restraint in accordance with the present invention employing a slidingly configurable locking interference mechanism, the first and second branches 102 and 104 are formed of any material or combination of materials providing sufficient stiffness and strength to be pushed through the leash-retaining portion 74 of the collar 42 and to provide stable support and confinement for the pedestal 116 and the wedge 118, which must be held properly in opposition in order to function in accordance with the present invention.

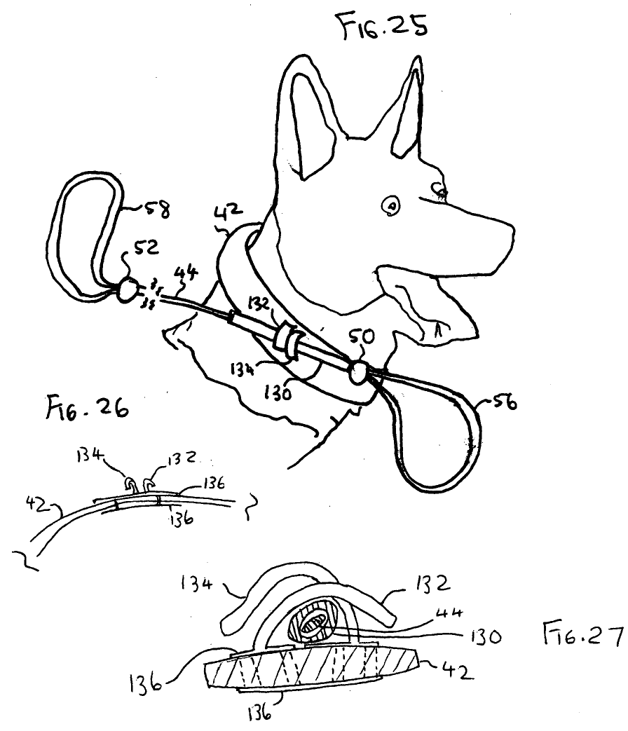

FIG. 24 shows a partial perspective view of another exemplary embodiment of the pet restraint in accordance with the present invention including a collar 42 on which are disposed spaced apart normally closed spring biased first carabiner 122 and second carabiner 124 and, therebetween, first and second leash-confining walls 126 and 128. A leash 44 having first ball 62, second ball 64, first loop 56 and second loop 58 is disposed on the collar 42, passing through the first carabiner 122 and second carabiner 124 and over the collar 4 between first and second leash-confining walls 126 and 128, which prevent the leash 44 from shifting sideways and biting into the dog's neck when under tension. When it is desired to disengage the leash from the collar, the carabiners 122 and 124 are manually, momentarily forced open and the leash 44 is displaced sideways out of the carabiners 122 and 124 and out from between the intervening first and second leash-confining walls 126 and 128. Carabiners 122 and 124 typically are formed of aluminum, steel or a high-strength polymer, derive their normally closed bias from an elastic structure of spring steel or elastic polymer, and may be anchored to the collar 42 by tacks, rivets, glue, stitching, embedding, or the like. The leash-confining walls 126 and 128 are formed of any material having sufficient stiffness to confine the leash 44 and sufficient flexibility to function comfortably as part of the collar 42, and are attached to the collar 42 by such means as stitching, tacks, glue, rivets, embedding or the like (or may be formed integrally with the collar, as, for example, if the collar is injection-molded or formed as a composite of fibrous or granular material and resinous material.

FIG. 25 shows a perspective view of another exemplary embodiment of the pet restraint in accordance with the present invention including a collar 42 from which project a first hook 132 and a second hook 134. A tubular leash guide 130 is firmly clamped beneath the first hook 132 and second hook 134. A leash 44 is slidably disposed through the leash guide 130 and includes a first loop 56, first ball 50, second loop 58 and second ball 52. This exemplary embodiment is distinguished in that the leash guide 130 may be disengaged by manipulating it out of the first and second hooks 132 and 134, but is not likely to disengage unintentionally when the leash 44 is pulled, because the hooks 132 and 134 are oppositely oriented and proximate one another.

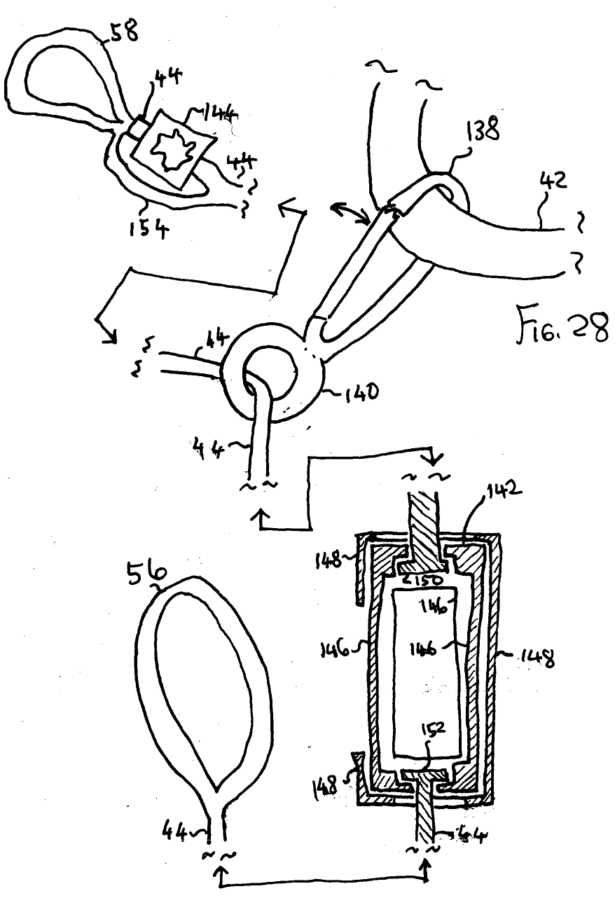

FIG. 26 shows this embodiment in perspective viewing a portion of the collar 42 edge-on, including the first and second hooks 132 and 134, which are held onto the collar 42 by a base assembly 136.

FIG. 27 shows this embodiment including the collar 42 (sectional view), base assembly 136, first and second hooks 132 and 134, leash guide 130 (sectional view) and leash 44 (also shown sectionally). Optionally, the base assembly 136 may include a bearing or other structure enabling it to swivel relative to the leash, thereby enabling the leash guide 130 to swivel responsive to tension on the leash 44. Thus, when the dog steps over the leash with a front leg, the leash will draw one end of the leash guide 130 down toward the dog's chest, causing the other end to point upward, placing one loop 56 or 58 of the leash 44 within the handler's easy reach. Disengagement of the leash guide 130 from the hooks 132 and 134 leaves the dog with collar 42 free of the leash 44, which remains disposed through the leash guide 130. In another alternative embodiment, the hooks 130 and 132 are fixed on the leash guide 130 rather than on the collar 42, and dimension the hooks 130 and 132 to engage the collar 42 or a portion thereof, such as a bar or eyelets installed on the collar 42.

FIG. 28 shows a perspective view of another exemplary embodiment of a pet restraint in accordance with the present invention including a collar 42, a carabiner 138 engaged with the collar 42, a leash-guiding ring 140 engaged with the carabiner 138, and a leash 44 slidably disposed through the leash-guiding ring 140. The leash 44 has first loop 56 and second loop 58 for hand-holding, a first stop canister 142, and a second stop canister 144. Each stop canister 142, 144 is rigid, is too large to fit through the leash-guiding ring 140, and has an interior space sufficient for holding a small article such as a crumpled or folded waste-disposal bag, a key, or a pet food item; and additionally may be windowed (open, screened, or transparent) for viewing its contents, may be openable to allow access to the contents and closable to secure them, and may be uniquely colored so that the stop canisters 142, 144 are distinguishable one from the other. Thus, each stop canister 142, 144 serves both to keep the leash 44 engaged with the collar 44 regardless of which loop 56, 58 the handler is holding, and to provide the handler with a convenient place to stow items associated with the activity of walking the pet. The carabiner 138, being openable in the customary way (see curved arrow indicating arc of opening of hinged carabiner 138), provides for easy coupling and decoupling of the leash 44 and the collar 42. Optionally, the carabiner 138 is dimensioned relative to the stop canisters 142 and 144 such that they are too large to pass through the carabiner 138, so that the leash-guiding ring 140 can be omitted and the leash 44 can be passed through the carabiner 138. However, this arrangement may forcefully and repeatedly bring the stop canisters 142 and 144 into contact with the collar 42, defacing the collar 42 or the stop canisters 142 and 144. Alternatively, a leash-guiding ring 140 is integrated with the carabiner 138 as illustrated.

FIG. 28 also shows a sectional view of an exemplary embodiment of the stop canister 142 including windowed inner cylindrical wall 146 and a windowed outer cylindrical wall 148 which is rotatable relative to the inner cylinder 146 to align or misalign the respective windows, opening and closing the stop canister 142. Flanged leash ends 150 and 152 engage the stop canisters 142 and 144 (stop canister 144, constructed in the same manner as stop canister 142, is illustrated schematically). Many common structures are effective to join the leash 44 and loops 56 and 58 to the stop canisters 142 and 144. For example, the illustrated flanged leash ends 150 and 152 engage the stop canisters 142 and 144 while allowing rotation of the leash 44 and loops 56 and 58 relative to the stop canisters 142 and 144. Other examples include a loop-and ring, knot-and-ring, crimp, weld, or the like. It is important that each stop canister 142 and 144 be constructed and joined to the leash 44 with enough tensile strength, hardness, and stiffness to survive the tension of restraining a strong dog and the impingement of the stop canisters 142 and 144 upon the leash-guiding ring 140 or carabiner 138. Thus, steel or heavy-duty, high-strength plastic is recommended. The leash 42 may also include the illustrated leash segment 154 bypassing each stop canister 142 and 144 to divert tension past the walls 144 and 146 when the dog pulls. To take advantage of this embodiment, a person walking a dog may place a house key in one stop canister 142 and an empty plastic bag (for collecting dog droppings) in the other stop canister 144. Later, the bag is appropriately disposed of and the key retrieved. Alternatively, a pet identification or a pet treat may be stored.

As can be seen from the drawing figures and from the description, each embodiment of the pet restraint in accordance with the present invention solves a problem by addressing the need for a graceful, convenient, secure way of re-routing the leash after the pet steps over it—by allowing recovery of the opposite end of the leash from a location near the dog's neck and, preferably, in a convenient upward orientation at the dorsal aspect of the dog's neck. Certain embodiments also provide convenient disengagement and reengagement of the leash from the collar—endwise, others sideways. One provides for disengagement of a leash guide from a collar, the leash remaining disposed through the leash guide. Others also provide a mildly constrictive response of the collar to tension on the leash. Some have more moving parts, others fewer. While the specification describes particular embodiments of the present invention, those of ordinary skill can devise variations of the present invention without departing from the inventive concept. Appended to this description are claims intended to aid in the understanding of the invention.

1. A pet restraint, comprising a collar and a leash, said leash having a first end and a second end and a sliding range determined lengthwise thereon between said first end and said second end, said leash being retained on said collar and being lengthwise slideable within said sliding range relative to said collar.

2. Apparatus as set forth in claim 1 wherein said leash includes a blocking portion proximate an end thereof and said blocking portion cooperates with said collar to limit said sliding range.

3. Apparatus as set forth in claim 1 wherein said leash includes a loop proximate an end thereof.

4. Apparatus as set forth in claim 2 wherein said leash further includes a loop proximate said blocking portion.

5. Apparatus as set forth in claim 1 wherein said leash is retained on said collar over approximately 180 degrees around said collar.

6. A pet restraint, comprising:
a collar including at least one leash-retaining portion; and
a leash having a first end, a second end, a length extending between said first end and said second end, and a sliding range within said length,
said leash passing through said leash-retaining portion and being slideable, within said sliding range, relative to said leash-retaining portion.

7. Apparatus as set forth in claim 6 wherein said leash includes a blocking portion proximate an end thereof and said blocking portion cooperates with said collar to determine a limit of said sliding range.

8. Apparatus as set forth in claim 6 wherein said leash passes through said leash-retaining portion of said collar at a plurality of locations and said leash-retaining portion includes a leash-guiding structure between said locations.

9. Apparatus as set forth in claim 6 wherein said leash-retaining portion is formed integrally with said collar.

10. Apparatus as set forth in claim 6 wherein said leash-retaining portion subtends substantially 180 degrees around said collar.

11. Apparatus as set forth in claim 6 wherein said leash-retaining portion includes a stiffened leash-guiding portion.

12. Apparatus as set forth in claim 6 wherein said blocking portion is configurable either to pass through said leash-retaining portion or to interfere with said leash-retaining portion.

13. Apparatus as set forth in claim 12, wherein said blocking portion includes a first segment formed and dimensioned to be passable through said leash-retaining portion of said collar and a second segment formed and dimensioned to be passable through said leash-retaining portion of said collar,
said second segment being operatively connectable to said first segment in a first configuration such that said first segment and said second segment together are passable through said leash-retaining portion of said collar,
said second segment being operatively connectable to said first segment in a second configuration such that said first segment and said second segment together are impassable through said leash-retaining portion of said collar.

14. Apparatus as set forth in claim 13, wherein said leash includes a loop proximate an end thereof and wherein said loop includes a blocking portion, said blocking portion being manipulable to be passable through said leash-retaining portion or to be impassable therethrough.

15. A pet restraint, comprising a collar and a leash, said leash having a first end and a second end, said leash and collar cooperating either to retain said leash on said collar in lengthwise sliding relation to said collar within said sliding range, or to release said leash from said collar.

16. Apparatus as set forth in claim 15 wherein said releasing cooperation includes endwise escape of an end of said leash from said collar.

17. Apparatus as set forth in claim 16, wherein said endwise escape is facilitated by a torsionally configurable locking interference mechanism.

18. Apparatus as set forth in claim 16, wherein said endwise escape is facilitated by a slidingly configurable locking interference mechanism.

19. Apparatus as set forth in claim 15 wherein said releasing cooperation includes sideways escape of said leash from said collar.
